(19) United States
(12) Patent Application Publication
(10) Pub. No.: US 2013/0213233 A1
(43) Pub. Date: Aug. 22, 2013

(54) Filter Cartridge with Gas-Permeable Element

(71) Applicants: Jean-Luc Guichaoua, Combrit (FR); Jean-Yves Picard, Quimper (FR); Benoit Le Roux, Fouesnant (FR)

(72) Inventors: Jean-Luc Guichaoua, Combrit (FR); Jean-Yves Picard, Quimper (FR); Benoit Le Roux, Fouesnant (FR)

(73) Assignee: CUMMINS FILTRATION IP INC., Minneapolis, MN (US)

(21) Appl. No.: 13/591,321

(22) Filed: Aug. 22, 2012

(30) Foreign Application Priority Data
Feb. 17, 2012 (FR) 12/51493

(51) Int. Cl. B01D 19/00

(52) U.S. Cl. 96/6

(57) ABSTRACT

A filter cartridge includes a filtering medium having a tubular cavity and an upper flange having an orifice communicating with the tubular cavity. A gas-permeable element closes off the orifice and has a greater permeability than the filtering medium, and less resistance to gas flow than the filtering medium.

### CROSS-REFERENCE TO RELATED APPLICATION

This application claims the benefit of and priority from, and includes the disclosure of, French Patent Application No. 12/51493, filed Feb. 17, 2012, incorporated herein by reference.

### PARENT FRENCH APPLICATION

The following is an English translation in accordance with the above noted parent French application and the present disclosure.

The disclosure relates to the field of the designing and making of filter assemblies used to filter fluids flowing in motors and its implementation is particularly useful in fuel circuits.

Such filter assemblies consist of a filter element within which there is disposed a filter cartridge, which is generally cylindrical in shape and includes a filtering medium which can be made for example of paper, cardboard or again felt or another porous material, such as a synthetic non-woven material. This filtering medium is classically demarcated by two end plates or flanges.

Such filter cartridges generally cooperate with a center tube which may or may not be fixedly joined to the flanges. The external diameter of the tube is close to the internal diameter of the filtering medium, so as to limit the deformations of the medium caused by the pressure exerted inside the filter assembly.

The lower flanges can be extended so as to have means for placing and holding the cartridge in the filter assembly.

The upper flanges can comprise a vent communicating with a cavity provided in the center tube, to enable a degassing of the filter assembly, especially when it is being filled with liquid, and to thus prevent the gases from collecting at the upper part of the filter assembly in reducing, to an equivalent extent, the space available to the liquid to be filtered. This system is especially seen in systems where the liquid is “pushed” and, in particular, when the outlet for discharging filtered liquid is in the upper part of the filter element. It is usually said of such a filter that it works under pressure.

The publication WO 02/076568 presents a filter cartridge without internal center tube and with a vent in the upper flange, as well as a filter assembly working under suction and implementing a center tube to which there is attached the filter cartridge, the tube being mounted permanently in the filter assembly. Such a filter is usually said to be working under suction.

Now, it is noted that the presence of a vent in the upper flange favors not only the degassing but also an exit of unfiltered liquid, which is redirected towards the vessel, thus leading to a waste of energy in the feeding of liquid to be filtered.

Furthermore, the pumping of the outgoing gases tends to draw the unfiltered liquid to the vent, thus increasing the waste of energy.

The disclosure in one aspect is aimed especially at overcoming the drawbacks of the prior art.

More specifically, it is one aim of the disclosure to provide a filter assembly integrating degassing means that enable the full use of the filtering medium.

It is also an aim of the disclosure to propose a filter assembly of this kind for which the degassing means are simple to implement and cost little to manufacture.

These various aims, as well as others that shall appear here below, are achieved by means of a filter cartridge, comprising a filtering medium having a tubular cavity, said filtering medium being demarcated by an upper flange and a lower flange, said upper flange having an orifice communicating with said tubular cavity.

According to the disclosure, the filter cartridge comprises a gas-permeable element, fixedly joined to the upper flange, closing off said orifice of said upper flange, the permeability of said gas-permeable element being greater than that of said filtering medium.

The integration of a gas-permeable element, taking the form of a hardware part, placed at the orifice present in the upper flange, is capable of creating a filter between the gases and the other substances liable to pass through the orifice, such as the liquid to be filtered.

To ensure that these different substances do not pass through the orifice without having first crossed the gas-permeable element, the upper flange of the filter cartridge is made in such a way that the orifice is closed off by the gas-permeable element.

The filter cartridge thus integrates a means that enable the passage, through the upper flange, of the gases present in the filter assembly at the time of its filling with liquid and throughout the working of the filter, while at the same time offering the possibility of minimizing the outflow, at this place, of the liquid to be filtered.

Since the gas-permeable element has permeability greater than that of the filtering medium; the gases naturally tend to exit by the orifice, hence to move towards the gas-permeable element, thus creating a main degassing flow.

The gas-permeable element offers less resistance to the gas flows than does the filtering medium, but offers more resistance than does a vent as described in the prior art.

The gas-permeable element can equip the filter cartridges integrating an internal center tube as well as the filter cartridges intended to be installed on an internal center tube mounted as a permanent fixture in the filter assembly.

In any case, the gas-permeable element, in being fixedly joined to the filter cartridge, is not an integral part of a member remaining as a permanent fixture in the filter assembly or necessitating specific maintenance. On the contrary, at each replacement of the filter cartridge (an operation generally scheduled as a function of the number of hours of use or kilometers travelled in the case of a vehicle), a new gas-permeable element is attached, thus limiting the risk of its fouling and thus ensuring an optimal operation of the degassing means.

Advantageously, in one embodiment said orifice is centered on the axis of said tubular cavity and said gas-permeable element is centered on said orifice.

Thus, the orifice and the gas-permeable element are in the closest possible position to the internal center tube, thus favoring the homogeneity of the gas flow and minimizing the length of the degassing circuit. This position also makes it possible to preserve the uniformity of the volume included in the tubular cavity of the filter cartridge, in which the filtered liquid arrives.

Advantageously, the upper flange of the cartridge including the gas-permeable element can be made by single-molding, or by overmolding of the gas-permeable element. Other manufacturing techniques can however be also implemented.

According to one particular solution, said upper flange has an upper face and said gas-permeable element has a surface area greater than that of said orifice, covering said upper face of said upper flange at said orifice.

In this way, the filter created by the gas-permeable element can have a greater surface area, reducing the risk that it will get fouled with other non-gaseous substances. In addition, this can facilitate the fixed joining of the gas-permeable element with the upper flange of the cartridge. This can also contribute to simplifying and optimizing the closure of the orifice present in the upper flange.

According to one embodiment, said gas-permeable element comprises a peripheral part and a central part, said central part being characterized by its permeability to gas.

Thus, the gas-permeable element, fixedly joined to the upper flange of the filter cartridge, may be formed as a single piece, made out of only one material, but it can also result from the joining of two parts, possibly made out of different materials.

According to one solution, said central part of said gas-permeable element is made using cellulose, a polymer, mineral fibers, or a mixture of the foregoing fibers in variable proportions.

Such materials indeed make it possible to let through the gases while at the same time resisting the passage of fluids such as fuel to be filtered, in the case of a vehicle.

Advantageously, in one embodiment said central part of said gas-permeable element has a thickness of 0.5 mm to 2 mm.

In one solution, the thickness of said central part of said gas-permeable element is 1 mm.

In this way, the compromise found between permeability to gases and the retention of the other substances present in said filter assembly is optimized.

Advantageously, in one embodiment said orifice has, at the surface, a circular shape, the diameter of which is from 5 mm to 15 mm.

In one embodiment, said orifice has, at the surface, a circular shape, the diameter of which is 10 mm.

According to one advantageous solution, the external shape of said gas-permeable element is a disk, the diameter of which is from 8 mm to 18 mm.

In one embodiment, the external shape of said gas-permeable element is a disk, the diameter of which is 12 mm.

The degassing is thus carried out efficiently. The fluid does not return to the tank but joins the other part of the fluid that passes through the folded medium. Naturally, other forms and dimensions of the orifice and of the gas-permeable element can be envisaged without departing from the framework of the invention.

Other features and advantages of the disclosure shall appear more clearly from the following description of one embodiment of the disclosure given by way of an illustratory and non-exhaustive example, and from the drawings, of which:

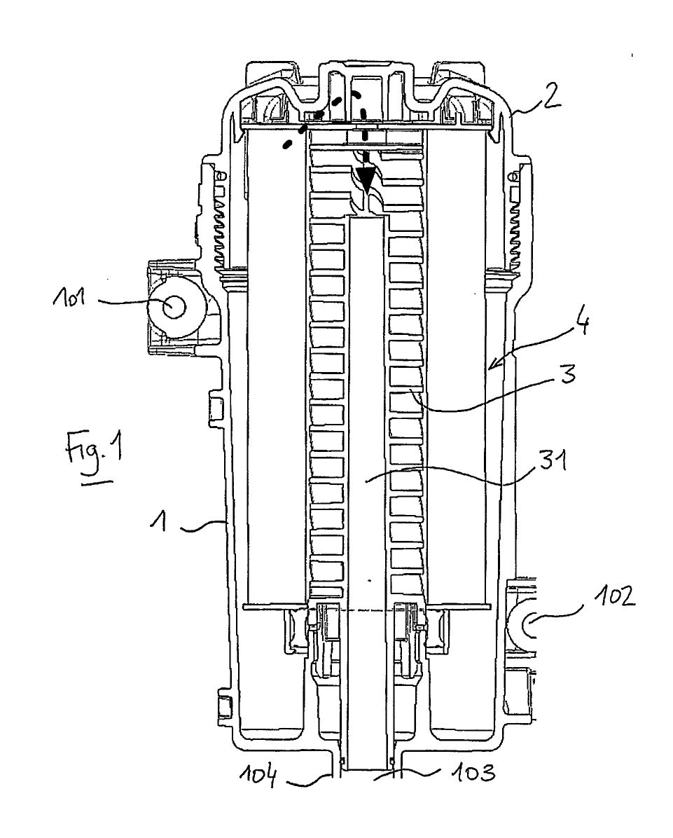

FIG. 1 illustrates a filter assembly integrating a filter cartridge according to one embodiment of the disclosure;

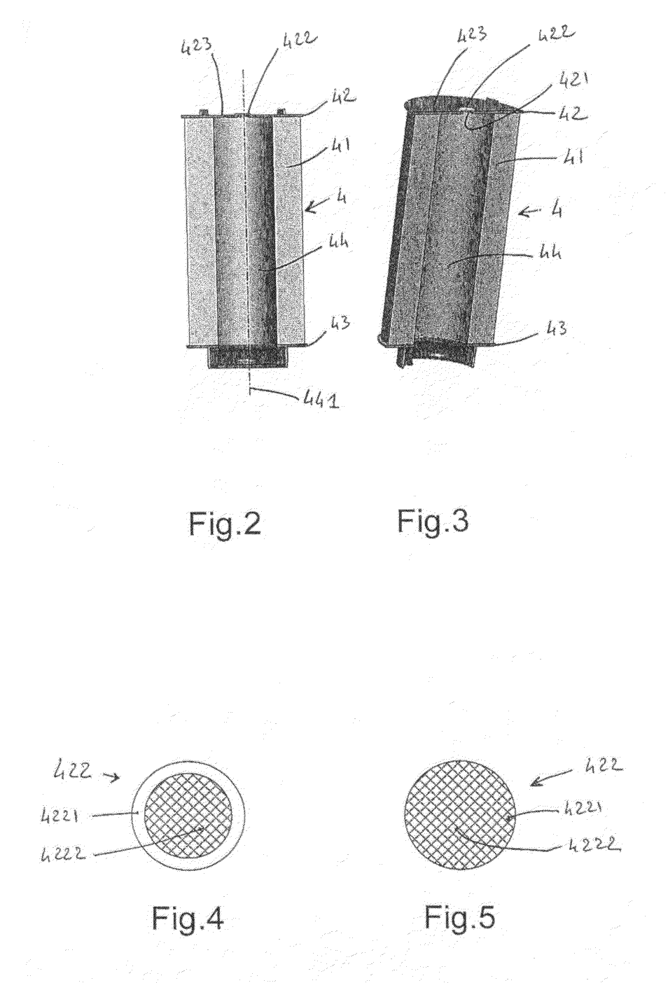

FIG. 2 illustrates a view in section of a filter cartridge according to one embodiment of the disclosure;

FIG. 3 gives a view in perspective of the section shown in FIG. 2;

FIG. 4 illustrates a top view of a gas-permeable element according to one embodiment of the disclosure;

FIG. 5 illustrates a top view of a gas-permeable element according to another embodiment of the disclosure.

FIG. 1 shows a filter assembly for liquid flowing in a hydraulic motor or apparatus comprising a vessel 1 and a lid 2 demarcating a volume within which there is mounted a tubular element 3 that supports a filtering cartridge 4 as shown in FIGS. 2 and 3.

The filter cartridge 4 comprises a filtering medium 41 demarcated by an upper flange 42 and a lower flange 43, as well as a tubular cavity 44.

The vessel 1 comprises a liquid intake orifice 101, a filtered liquid outlet orifice 102, an orifice 103 of a return conduit 104 leading to the reservoir of liquid.

The filter cartridge 4 is tightly fitted on to the tubular element 3 in such a way that the orifice 421, present in the upper flange 42 and communicating with the tubular cavity 44, also communicates with the central cavity 31 passing through the tubular element 3.

With this central cavity 31 opening on to the conduit 104, all the gases and liquids filtered by the orifice 421 are drawn by a pump which compresses these elements towards the second filter, called the main filter, the substances passing through the orifice 421 upstream being possibly discharged by the orifice 103 downstream.

According to one embodiment of the disclosure, the filter cartridge 4 has a gas-permeable element 422, fixedly joined to the upper flange 42, the orifice 421 of which it closes off.

According to one principle of the disclosure, this gas-permeable element 422 has permeability greater than that of the filtering medium 41, in such a way that the gases which accumulate during the feeding in liquid to be filtered tend to exit from the filter assembly, in following the path represented by the line of dashes in FIG. 1.

The designing of the gas-permeable element 422 relies on an appropriate dimensioning, as compared with the filtering medium 41, of the following parameters:

permeability, given that the gas-permeable element 422 must be more permeable than the filtering medium 41;

capillary pressure, inversely proportional to permeability, according to the formula P=4·γ·cos(θ)/D, where P represents the capillary pressure, γ the surface tension of the liquid, θ the angle of contact and D the pore diameter.

the surface area, which is preferably negligible as compared with the surface area of the filtering medium 41, to reduce its effect on the overall efficiency of the filter assembly. The ratio between the flows respectively passing through the gas-permeable element 422 (Qb) and the filtering medium 41 (Qf) is given approximately by the formula Qb/Qf=(Ab·Perm b)/(Af·Perm f), where A designates the surface area and Perm designates the permeability respectively of the gas-permeable element (index b) and of the filtering (index f).

For example, a gas-permeable element whose surface represents at most 1/6000th of the filtering surface of the filtering medium can be suitable, while permeability 16 times higher gives rise to a net ratio of about 1/360. At worst, with a filtering medium of an efficiency equal to 87%, with a gas-permeable element whose efficiency is 30%, and assuming that 1/360th of the flow passes through the gas-permeable element, the efficiency of the filtering medium is reduced by 0.05%, i.e. it attains 86.95%.

According to one embodiment of the disclosure, the gas-permeable element 422 represented is centered on the orifice 421, which is itself centered on the axis 441 of the tubular cavity 44.

As can be seen clearly in FIG. 2, the gas-permeable element 422 furthermore has a greater surface area than the orifice 421, enabling it to be fixedly joined to the upper face 423 of the upper flange 42 and to cover this upper face 423 at the orifice 421.

The gas-permeable element 422, according to the embodiments illustrated by FIGS. 4 and 5, can be broken down into a peripheral part 4221 and a central part 4222.

Whatever the embodiment, the central part 4222 is permeable to gas, while the peripheral part 4221 is not necessarily so (the case of FIG. 4, as opposed to FIG. 5).

The peripheral part 4221 can indeed in certain cases have the sole function of providing for the link with the upper flange of the filtering cartridge.

According to one embodiment, the central part 4222 is made as a filtering medium, which may or may not be woven, based on cellulose or synthetic or mineral (class) fibers and a thickness of about 1 mm.

Similarly, the orifice 421 has, on the surface, a circular shape with a diameter of about 8 mm and the gas-permeable element 422 has the external shape of a disk with a diameter 12 mm.

Thus, during the filling of the filter assembly with liquid, and during the operation of the filter, the gas contained in the vessel passes through the gas-permeable element 422, then through the orifice 421, by the central cavity 31 and by the conduit 104, and finally exits from the filter assembly through the orifice 103.

At the same time, the flow of liquid to be filtered is limited by the gas-permeable element 422, and gets concentrated on the filtering medium 41.

Other embodiments can of course be envisaged, based on the principles just described of the filter cartridge integrating a gas-permeable element in the upper flange, without departing from the framework of the disclosure.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

What is claimed is:

1. Filter cartridge comprising a filtering medium having a tubular cavity, said filtering medium being demarcated by an upper flange and a lower flange, said upper flange having an orifice communicating with said tubular cavity, characterized in that it comprises a gas-permeable element, fixedly joined to the upper flange, closing off said orifice of said upper flange, the permeability of said gas-permeable element being greater than that of said filtering medium.

2. Filter cartridge according to claim 1, characterized in that said orifice is centered on the axis of said tubular cavity and in that said gas-permeable element is centered on said orifice.

3. Filter cartridge according to claim 1, wherein the upper flange has an upper face characterized in that said gas-permeable element has a surface area greater than that of said orifice, covering said upper face of said upper flange at said orifice.

4. Filter cartridge according to claim 1, characterized in that said gas-permeable element comprises a peripheral part and a central part, said central part being characterized by its permeability to gas.

5. Filter cartridge according to claim 4, characterized in that said central part of said gas-permeable element is made using cellulose, a polymer, mineral fibers, or a mixture of the foregoing fibers in variable proportions.

6. Filter cartridge according to claim 5, characterized in that said central part of said gas-permeable element has a thickness of 0.5 mm to 2 mm.

7. Filter cartridge according to claim 5, characterized in the thickness of said central part of said gas-permeable element is 1 mm.

8. Filter cartridge according to claim 1, characterized in that said orifice has, at the surface, circular shape, the diameter of which is from 5 mm to 15 mm.

9. Filter cartridge according to claim 1, characterized in said orifice has, at the surface, a circular shape, the diameter of which is 8 mm.

10. Filter cartridge according to claim 8, characterized in that the external shape of said gas-permeable element is a disk, the diameter of which is from 8 mm to 18 mm.

11. Filter cartridge according to claim 8, characterized in that the external shape of said gas-permeable element is a disk, the diameter of which is 12 mm.

12. A filter cartridge comprising a filtering medium having a tubular cavity and an upper flange having an orifice communicating with said tubular cavity, a gas-permeable element at said upper flange closing said orifice, said gas-permeable element having less resistance to gas flow than said filtering medium and more resistance to gas flow than an open vent.

13. The filter cartridge according to claim 12 wherein said gas-permeable element has a surface area greater than that of said orifice.

14. The filter cartridge according to claim 12 wherein said tubular cavity extends along an axis, and each of said orifice and said gas-permeable element is centered on said axis.
